(19) United States
(12) Patent Application Publication
(10) Pub. No.: US 2013/0199466 A1
(43) Pub. Date: Aug. 8, 2013

(54) MULTI-CYLINDER INTERNAL COMBUSTION ENGINE AND METHOD FOR OPERATING A MULTI-CYLINDER INTERNAL COMBUSTION ENGINE OF SAID TYPE

(71) Applicant: FORD GLOBAL TECHNOLOGIES, LLC, Dearborn, MI (US)

(72) Inventors: Rainer Friedfeldt, Huerth (DE); Guenter Bartsch, Gummersbach (DE)

(73) Assignee: FORD GLOBAL TECHNOLOGIES, LLC, Dearborn, MI (US)

(21) Appl. No.: 13/753,411

(22) Filed: Jan. 29, 2013

(30) Foreign Application Priority Data
Feb. 8, 2012 (EP) 12154407.6

(51) Int. Cl. F02B 75/32

(52) U.S. Cl. CPC F02B 75/32
USPC 123/90.1; 123/197.4

(57) ABSTRACT

A system for an engine comprising: a crankshaft with four crank throws, wherein, the first and the second crank throw are arranged offset by 180° CA from the third and the fourth crank throws; four cylinders corresponding to the four crank throws, the four cylinders arranged in two cylinder groups, the first cylinder group comprising the first and second cylinder, and the second cylinder group comprising the third and fourth cylinder; an exhaust manifold, wherein, exhaust lines within each of the two cylinder groups merge forming two component exhaust lines, and the two component exhaust lines merge into an overall exhaust line; and an ignition sequence such that each ignition is offset by 180° CA, and ignition of cylinders within the two cylinder groups is offset by 360° CA. In this way exhaust lines within the exhaust manifold can remain short and backpressure from sequential, adjacent cylinder ignition is minimized.

### CROSS REFERENCE TO RELATED APPLICATIONS

The present application claims priority to European Patent Application No. 12154407.6 filed on Feb. 8, 2012, the entire contents of which are hereby incorporated by reference for all purposes.

### TECHNICAL FIELD

The present application relates to exhaust gas discharge for internal combustion engines.

### BACKGROUND AND SUMMARY

Internal combustion engines are made up of an engine block, which contains at least one combustion chamber, and at least one cylinder head, which caps the at least one combustion chamber. The cylinder head contains intake and exhaust valves leading to ducting for the intake of fresh air charge and exhaust of combustion products. Traditionally, inlet ducts which lead to the intake inlet openings, and the outlet ducts, that is to say the exhaust lines which adjoin the exhaust outlet openings, are at least partially integrated in the cylinder head. The exhaust lines of the cylinders are generally merged to form a common overall exhaust line. The merging of exhaust lines to form an overall exhaust line is referred to generally, and within the context of the present disclosure, as an exhaust manifold, wherein the exhaust manifold can be regarded as belonging to the exhaust-gas discharge system.

It is common for the exhaust lines of four cylinders to be merged to form a single overall exhaust line, such that one exhaust manifold is formed. In the case of a 4-cylinder in line engine, the exhaust lines of the cylinders are merged in stages, specifically in such a way that in each case the line of an outer cylinder and the exhaust line of the adjacent inner cylinder merge to form a component exhaust line. The two component exhaust lines, formed in this way, of the four cylinders or two cylinder groups merge to form an overall exhaust line. In this way it is possible for the overall length of all of the exhaust lines and thus the volume of the manifold to be reduced considerably. Furthermore, the exhaust manifold formed may be partially or completely integrated in the at least one cylinder head.

The dynamic wave phenomena, resulting from pressure fluctuations in the exhaust-gas discharge system, are the reason that the cylinders of a multi-cylinder engine, operating in a thermodynamically offset manner, can influence one another. In particular the cylinders impede one another, during the charge exchange. This can result in an impaired torque characteristic and a reduced power availability. If the exhaust lines of the individual cylinders are guided separately from one another over a relatively long distance, the mutual influencing of the cylinders during the charge exchange can be counteracted.

The evacuation of the combustion gases out of a cylinder of the internal combustion engine during the charge exchange is based substantially on two different mechanisms. When the outlet valve opens, close to bottom dead center, at the start of the charge exchange, the combustion gases flow at high speed through the outlet opening into the exhaust-gas discharge system on account of the high pressure level prevailing in the cylinder at the end of the combustion and the associated high pressure difference between the combustion chamber and exhaust manifold. The pressure-driven flow process is assisted by a high pressure peak which is also referred to as a pre-outlet shock. This pre-outlet shock propagates along the exhaust line at the speed of sound, with the pressure being dissipated, that is to say reduced, to a greater or lesser extent with increasing distance traveled, and in a manner dependent on the guidance of the line, as a result of friction.

During the further course of the charge exchange, the pressures in the cylinder and in the exhaust line are substantially equalized, and so the combustion gases are discharged substantially as a result of the stroke movement of the piston.

Depending on the specific embodiment of the exhaust-gas discharge system, the pressure waves originating from a cylinder run not only through the at least one exhaust line of the cylinder but rather also along the exhaust lines of the other cylinders, possibly to the outlet opening provided and open at the end of the respective line.

Exhaust gas which has already been expelled or discharged into an exhaust line during the charge exchange can thus pass back into the cylinder again, specifically, as a result of the pressure wave originating from another cylinder.

For example, in the case of a four-cylinder in-line engine whose cylinders are operated in the sequence 1-3-4-2, short exhaust lines may also have the effect that the fourth cylinder adversely affects the preceding third cylinder in the ignition sequence. That is to say the cylinder ignited previously, during the charge exchange, and exhaust gas originating from the fourth cylinder passes into the third cylinder before the outlet valves thereof close.

The above-described problem concerning the mutual influencing of the cylinders during the charge exchange is of increasing relevance in the structural design of internal combustion engines, because in exhaust manifold design, there is a trend in development toward short exhaust lines.

However, for numerous reasons, it is advantageous for the exhaust lines of the cylinders starting from the respective outlet opening to the collecting point in the exhaust manifold to be as short as possible. For example, it is advantageous for the exhaust manifold to be substantially integrated into the at least one cylinder head and for the merging of the exhaust lines to form an overall exhaust line to take place, to the greatest possible extent, in the cylinder head. Firstly, this leads to a more compact design of the internal combustion engine and to denser packaging of the drive unit as a whole in the engine bay. Secondly, there are resulting cost advantages in manufacture and assembly, and a weight reduction, in particular in the case of a complete integration of the exhaust manifold into the cylinder head.

Furthermore, short exhaust lines can have an advantageous effect on the arrangement and the operation of an exhaust-gas aftertreatment system which is provided downstream of the cylinders. The path of the hot exhaust gases to the exhaust-gas aftertreatment systems should be as short as possible such that the exhaust gases are given little time to cool down and the exhaust-gas aftertreatment systems reach their operating temperature as quickly as possible, in particular after a cold start of the internal combustion engine. In this way, it is sought to minimize heat loss in the part of the exhaust lines between the outlet opening at the cylinder and the exhaust-gas aftertreatment system. This can be achieved by reducing the mass and the length of the part, that is to say, by shortening the corresponding exhaust lines.

In the case of internal combustion engines supercharged by an exhaust-gas turbocharger, it is sought to arrange the turbine as close as possible to the outlet openings of the cylinders in order to optimally utilize the exhaust-gas enthalpy of the hot exhaust gases, which is determined significantly by the exhaust-gas pressure and the exhaust-gas temperature ensuring a fast response behavior of the turbocharger. Here, too, the thermal inertia and the volume of the line system between the outlet openings of the cylinders and the turbine should be minimized. For this reason, it is expedient for the exhaust lines to be shortened, for example through at least partial integration of the exhaust manifold into the cylinder head.

The exhaust manifold is increasingly being integrated into the cylinder head in order to be incorporated into a cooling arrangement provided in the cylinder head such that the manifold need not be produced from thermally highly loadable materials, which are expensive.

The shortening of the exhaust lines of the exhaust manifold, for example through integration into the cylinder head, has numerous advantages, as discussed above, but leads to a shortening of the overall length of all of the exhaust lines but also to a shortening of the individual exhaust lines, as these are merged directly downstream of the outlet openings. This shortening of individual exhaust lines problematically results in intensifying the mutual influencing of the cylinders during the charge exchange.

In view of the above stated disadvantages, the present disclosure, in one embodiment, provides an internal combustion engine with a short exhaust manifold and exhaust lines which eliminates or alleviates mutual influencing of the cylinders during charge exchange. This is achieved by an exhaust manifold for a 4 cylinder in-line engine where exhaust lines from the first and second cylinders merge into a component exhaust line and the exhaust lines of the third and fourth cylinders merge into a component exhaust line. The two component exhaust lines merge into an overall exhaust line. Separation of the exhaust lines into two cylinder groups allows for an ignition sequence, described below, in which combustion of the cylinders within a group is offset by 360° CA, eliminating or minimizing the mutual influencing of cylinders.

The internal combustion engine according to one embodiment is an internal combustion engine which has a compact exhaust manifold with short exhaust lines and which simultaneously eliminates the problem of the mutual influencing of the cylinders during the charge exchange. Further, a method may be provided in which, in the four cylinders, the combustion is initiated at intervals of 180° CA and within the cylinders of a group combustion is offset by 360° CA.

The initiation, that is to say introduction, of the combustion may take place either by externally-applied ignition, for example by a spark plug, or else by auto-ignition or compression ignition. In this respect, the method can be implemented in applied-ignition engines and also in diesel engines and hybrid internal combustion engines.

That which has been stated in connection with the internal combustion engine according to the disclosure likewise applies to the method according to the disclosure.

In internal combustion engines whose cylinders are equipped with ignition devices for initiating an applied ignition, method variants may be advantageous wherein the cylinders are ignited by ignition devices in the sequence 1-3-2-4 and at intervals of 180° CA. Here, the cylinders are enumerated and numbered sequentially along the longitudinal axis of the at least one cylinder head proceeding from an outer cylinder.

Method variants may however also be advantageous in which the cylinders are ignited by means of ignition devices in the sequence 1-4-2-3 and at intervals of 180° CA. Here, the cylinders are enumerated and numbered sequentially along the longitudinal axis of the at least one cylinder head proceeding from an outer cylinder.

In the two above method variants, the two cylinders of a cylinder group have the greatest possible offset with regard to their working processes, specifically a thermodynamic offset of 360° CA. The combustion is initiated by means of applied ignition alternately in a cylinder of one cylinder group and a cylinder of the other cylinder group.

The present disclosure describes a system for an engine comprising: a crankshaft with four crank throws, wherein, the first and the second crank throw are arranged offset by 180° CA from the third and the fourth crank throws; four cylinders corresponding to the four crank throws, the four cylinders arranged in two cylinder groups, the first cylinder group comprising the first and second cylinder, and the second cylinder group comprising the third and fourth cylinder; an exhaust manifold, wherein, exhaust lines within each of the two cylinder groups merge forming two component exhaust lines, and the two component exhaust lines merge into an overall exhaust line; and an ignition sequence such that each ignition is offset by 180° CA, and ignition of cylinders within a cylinder group is offset by 360° CA. In this way exhaust lines within the exhaust manifold can remain short and the mutual influencing of sequential, adjacent cylinder ignition is minimized.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows an example cylinder of an engine in accordance with the present disclosure.

FIG. 2 schematically shows a plan view of that portion of the exhaust manifold which is integrated in the cylinder head, in a first embodiment of the internal combustion engine.

FIG. 3 schematically shows a plan view of that portion of the exhaust manifold which is integrated in the cylinder head, in a second embodiment of the internal combustion engine.

FIG. 4 shows an embodiment of the crankshaft of the internal combustion engine as a diagrammatic sketch.

FIG. 5 shows a flow chart of cylinder events corresponding to crankshaft rotation.

### DETAILED DESCRIPTION

In an exhaust manifold in accordance with the present disclosure the exhaust lines of the four cylinders of the at least one cylinder head of the internal combustion engine are, in a first stage, merged in groups, that is to say in pairs. In each pair, one outer cylinder and the adjacent inner cylinder form a cylinder pair, the exhaust lines of which merge to form a component exhaust line. In a second stage, the component exhaust lines are then merged, downstream in the exhaust-gas discharge system, to form an overall exhaust line. The overall length of all the exhaust lines is shortened in this way. The stepped merging of the exhaust lines to form an overall exhaust line furthermore contributes to a more compact design which occupies less volume in an engine compartment.

According to the disclosure, the exhaust-gas flows of the two cylinder groups are kept separate from one another for longer than the exhaust-gas flows within a group. The design of the component exhaust lines and the increased length of isolation from one another may have the effect of decreasing influence of one cylinder group on the other cylinder group during the charge exchange.

Owing to the structural design of the exhaust manifold, in particular the formation of component exhaust lines, it is possible for the cylinders of a group to hinder one another during the charge exchange. This problem is alleviated through the selection of a suitable ignition sequence. The four cylinders are operated in such a way that the cylinders of one cylinder group have as great as possible an offset with regard to the working processes. That is to say the combustion is initiated, for example, by means of applied ignition, alternately in a cylinder of one cylinder group and in a cylinder of the other cylinder group. Here, method variants may be advantageous in which the cylinders are ignited in the sequence 1-3-2-4 or in the sequence 1-4-2-3. The numbering of the cylinders of an internal combustion engine is defined in DIN 73021. In the case of in-line engines, the cylinders are enumerated sequentially.

The cylinders are ignited at intervals of, in each case, 180° CA, such that, proceeding from the first cylinder, the ignition times measured in ° CA are as follows: 0-180-360-540. Consequently, the cylinders of a cylinder group have a thermodynamic offset of 360° CA.

If it is also taken into consideration that the outlet valves generally have an opening duration of between 220° CA and 260° CA, it is clear that, with the selected ignition sequence, the cylinders of a group cannot influence one another during the charge exchange, specifically entirely regardless of how short the distance is to the merging of the exhaust lines downstream of the outlet openings to form a component exhaust line.

An ignition sequence which deviates from the conventional 1-3-4-2 ignition sequence also demands a crankshaft which differs from a conventional crankshaft, that is to say a crankshaft throw configuration which differs from the conventional crankshaft throw configuration.

According to the disclosure, a crankshaft is used with which the cylinders of a cylinder group are mechanically synchronous, that is to say pass through top dead center and bottom dead center at the same time. For this purpose, the associated crankshaft throws of the two cylinders have no offset in the circumferential direction about the longitudinal axis of the crankshaft. The thermodynamic offset of 360° CA is then realized by means of the ignition sequence.

In order to realize an ignition interval of 180° CA across the entirety of the four cylinders, the crankshaft throws of one cylinder group are rotated, that is to say offset, by 180° in the circumferential direction in relation to the crankshaft throws of the other cylinder group.

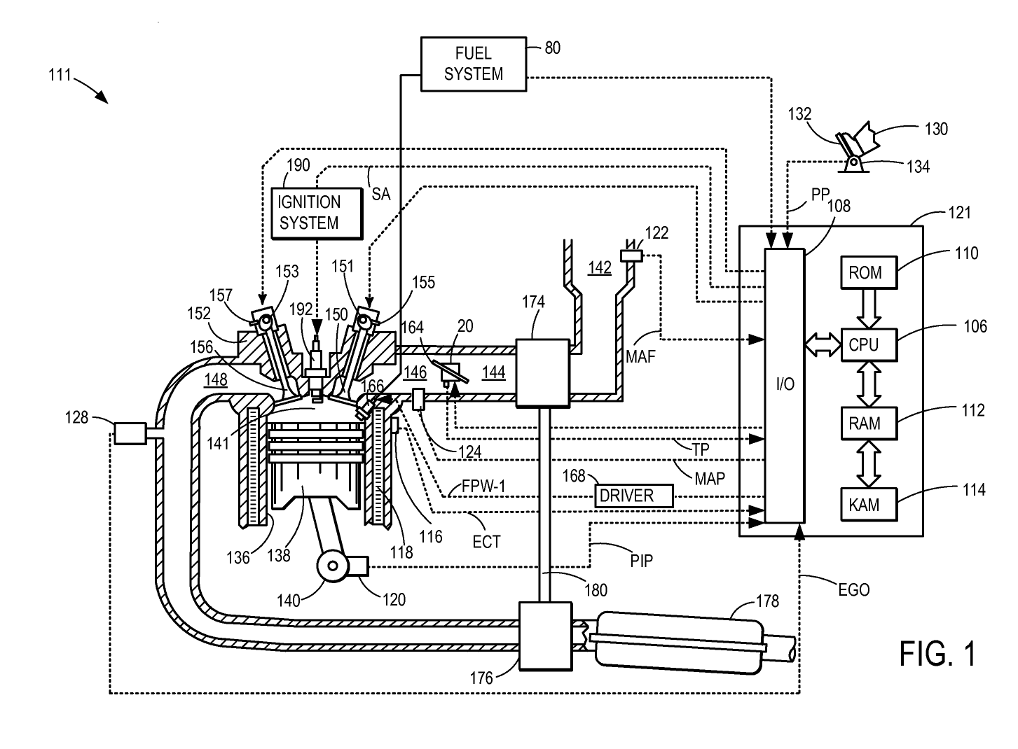

Referring now to the figures, FIG. 1 depicts an example embodiment of a combustion chamber or cylinder of internal combustion engine 111. Engine 111 may receive control parameters from a control system including controller 121 and input from a vehicle operator 130 via an input device 132. In this example, input device 132 includes an accelerator pedal and a pedal position sensor 134 for generating a proportional pedal position signal PP. Cylinder (herein also “combustion chamber”) 141 of engine 111 may include combustion chamber walls 136 with piston 138 positioned therein and is capped by cylinder head 152. Cylinder head 152 may be contiguous with the head of other cylinders (not shown). A cooling jacket (not shown) may be arranged in cylinder head 152 and/or within combustion chamber walls 136. Piston 138 may be coupled to crankshaft 140 so that reciprocating motion of the piston is translated into rotational motion of the crankshaft. Crankshaft 140 may be coupled to at least one drive wheel of the passenger vehicle via a transmission system. Further, a starter motor may be coupled to crankshaft 140 via a flywheel to enable a starting operation of engine 111.

Embodiments of the internal combustion engine are advantageous in which the at least one cylinder head is equipped with an integrated coolant jacket. In particular, supercharged internal combustion engines are thermally highly loaded, as a result of which high demands are placed on the cooling arrangement.

It is possible for the cooling arrangement to take the form of an air-type cooling arrangement or a liquid-type cooling arrangement. However, it is possible for greater quantities of heat to be dissipated using a liquid-type cooling arrangement than is possible using an air-type cooling arrangement.

Liquid cooling requires the internal combustion engine, that is to say the cylinder head or the cylinder block, to be equipped with an integrated coolant jacket, that is to say the arrangement of coolant ducts which conduct the coolant through the cylinder head or cylinder block. The heat is dissipated to the coolant already in the interior of the component. The coolant is fed by means of a pump (not shown) arranged in the cooling circuit, such that the coolant circulates in the coolant jacket. The heat which is dissipated to the coolant is in this way dissipated from the interior of the head or block and extracted from the coolant again in a heat exchanger (not shown).

Cylinder 141 can receive intake air through inlets in cylinder head 152 via a series of intake air passages 142, 144, and 146. Intake air passage 146 may communicate with other cylinders of engine 111 in addition to cylinder 141. In some embodiments, one or more of the intake passages may include a boosting device such as a turbocharger or a supercharger. For example, FIG. 1 shows engine 111 configured with a turbocharger including a compressor 174 arranged between intake passages 142 and 144, and an exhaust turbine 176 arranged along exhaust passage 148. Compressor 174 may be at least partially powered by exhaust turbine 176 via a shaft 180 where the boosting device is configured as a turbocharger. However, in other examples, such as where engine 111 is provided with a supercharger, exhaust turbine 176 may be optionally omitted, where compressor 174 may be powered by mechanical input from a motor or the engine. A throttle 20 including a throttle plate 164 may be provided along an intake passage of the engine for varying the flow rate and/or pressure of intake air provided to the engine cylinders. For example, throttle 20 may be disposed downstream of compressor 174 as shown in FIG. 1, or alternatively may be provided upstream of compressor 174.

Embodiments of the internal combustion engine are advantageous in which the internal combustion engine is a naturally aspirated engine.

In particular, however, embodiments of the internal combustion engine are advantageous in which a supercharging device is provided. The exhaust gases in the cylinders of a supercharged internal combustion engine are at considerably higher pressures during the operation of the internal combustion engines, as a result of which the dynamic wave phenomena in the exhaust-gas discharge system during the charge exchange, in particular the pre-outlet shock, are considerably more pronounced.

Accordingly, the problem of the mutual influencing of the cylinders during the charge exchange is of even greater relevance in the case of supercharged internal combustion engines.

Embodiments of the internal combustion engine are advantageous in particular in which at least one exhaust-gas turbocharger is provided which comprises a turbine arranged in the exhaust-gas discharge system.

The advantages of an exhaust-gas turbocharger for example in relation to a mechanical charger are that no mechanical connection for transmitting power exists or is required between the charger and internal combustion engine. While a mechanical charge draws the energy required for driving it entirely from the internal combustion engine, the exhaust-gas turbocharger utilizes the exhaust-gas energy of the hot exhaust gases. The energy imparted to the turbine by the exhaust-gas flow is utilized for driving a compressor which delivers and compresses the charge air supplied to it, whereby supercharging of the cylinders is achieved. A charge-air cooling arrangement may be provided, by means of which the compressed combustion air is cooled before it enters the cylinders.

Supercharging serves primarily to increase the power of the internal combustion engine. Supercharging is however also a suitable means for shifting the load collective toward higher loads for the same vehicle boundary conditions, whereby the specific fuel consumption can be lowered.

Embodiments of the internal combustion engine are advantageous in particular in which two exhaust-gas turbochargers are provided which comprise two turbines arranged in the exhaust-gas discharge system.

If one exhaust-gas turbocharger is provided, a torque drop is often observed when a certain engine rotational speed is undershot. The torque drop is understandable if one takes into consideration that the charge pressure ratio is dependent on the turbine pressure ratio. For example, if the rotational speed is reduced, this leads to a smaller exhaust-gas mass flow and therefore to a lower turbine pressure ratio. This has the result that, toward lower engine speeds, the charge pressure ratio likewise decreases, which equates to a torque drop.

Here, it is fundamentally possible for the drop in charge pressure to be counteracted by means of a reduction in the size of the turbine cross section, and the associated increase in the turbine pressure ratio, which however leads to disadvantages at high rotational speeds.

It is therefore often sought to increase the torque characteristic of a supercharged internal combustion engine through the use of more than one exhaust-gas turbocharger, that is to say by means of a plurality of turbochargers arranged in parallel or in series, that is to say by means of a plurality of turbines arranged in parallel or in series.

If two exhaust-gas turbochargers are provided, embodiments of the internal combustion engine are advantageous in which the two turbines in the overall exhaust line are arranged in series.

By connecting two exhaust-gas turbochargers in series, of which one exhaust-gas turbocharger serves as a high-pressure stage and one exhaust-gas turbocharger serves as a low-pressure stage, the compressor characteristic map can advantageously be expanded, specifically both in the direction of smaller compressor flows and also in the direction of larger compressor flows.

In particular, with the exhaust-gas turbocharger which serves as a high-pressure stage, it is possible for the surge limit to be shifted in the direction of smaller compressor flows, as a result of which high charge pressure ratios can be obtained even with small compressor flows, which increases the torque characteristic in the lower part-load range. This is achieved by designing the high-pressure turbine for small exhaust-gas mass flows and by providing a bypass line by means of which, with increasing exhaust-gas mass flow, an increasing amount of exhaust gas is conducted past the high-pressure turbine. For this purpose, the bypass line branches off from the exhaust system upstream of the high-pressure turbine and opens into the exhaust system again downstream of the turbine, wherein a shut-off element is arranged in the bypass line in order to control the exhaust-gas flow conducted past the high-pressure turbine.

The response behavior of an internal combustion engine supercharged in this way is considerably increased, in particular in the part-load range, in relation to a similar internal combustion engine with single-stage supercharging. The reason for this can also be considered to be the fact that the relatively small high-pressure stage is less inert than a relatively large exhaust-gas turbocharger used for single-stage supercharging, because the rotor of an exhaust-gas turbocharger of smaller dimensions can accelerate and decelerate more quickly.

The turbine of the at least one exhaust-gas turbocharger may be equipped with a variable turbine geometry, which permits a more comprehensive adaptation to the respective operating point of the internal combustion engine through adjustment of the turbine geometry or of the effective turbine cross section. Here, adjustable guide blades for influencing the flow direction are arranged in the inlet region of the turbine. In contrast to the rotor blades of the rotating rotor, the guide blades do not rotate with the shaft of the turbine.

If the turbine has a fixed, invariable geometry, the guide blades are arranged in the inlet region so as to be stationary but also completely immovable, that is to say rigidly fixed. In contrast, in the case of a variable geometry, the guide blades are duly also arranged so as to be stationary but not so as to be completely immovable, rather so as to be rotatable about their axis, such that the flow approaching the rotor blades can be influenced.

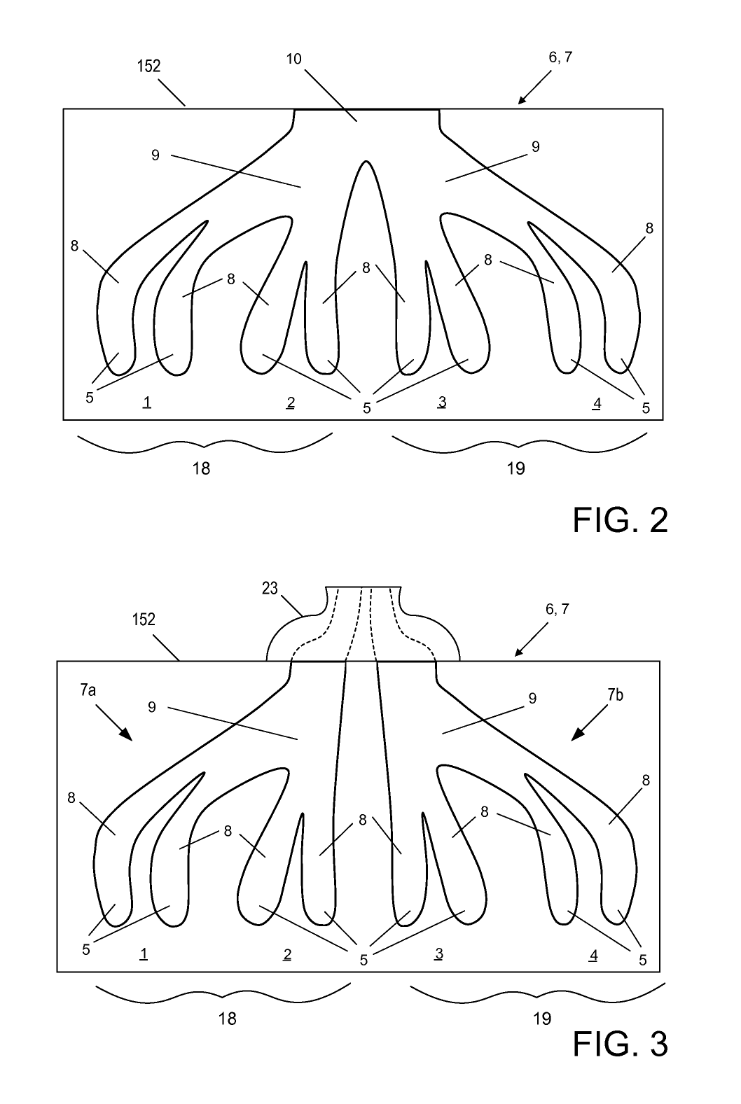

Exhaust passage 148 may receive exhaust gases from other cylinders of engine 111 in addition to cylinder 141 via an exhaust manifold, such as those shown in detail in FIGS. 2 and 3. Exhaust gas sensor 128 is shown coupled to exhaust passage 148 upstream of emission control device 178. Sensor 128 may be selected from among various suitable sensors for providing an indication of exhaust gas air/fuel ratio such as a linear oxygen sensor or UEGO (universal or wide-range exhaust gas oxygen), a two-state oxygen sensor or EGO (as depicted), a HEGO (heated EGO), a NOx, HC, or CO sensor, for example. Emission control device 178 may be a three way catalyst (TWC), NOx trap, various other emission control devices, or combinations thereof.

Internal combustion engines are equipped with various exhaust-gas aftertreatment systems in order to reduce pollutant emissions. For the oxidation of unburned hydrocarbons and of carbon monoxide, an oxidation catalytic converter may be provided in the exhaust system. In applied-ignition engines, use is made of catalytic reactors, in particular three-way catalytic converters, with which nitrogen oxides are reduced by means of the non-oxidized exhaust-gas components, specifically the carbon monoxides and the unburned hydrocarbons, wherein the exhaust-gas components are simultaneously oxidized. In internal combustion engines which are operated with an excess of air, that is to say for example applied-ignition engines which operate in the lean-burn mode, but in particular direct-injection diesel engines or else direct-injection applied-ignition engines, the nitrogen oxides contained in the exhaust gas cannot be reduced out of principle, owing to the lack of reducing agent. To reduce the nitrogen oxides, use is made of SCR catalytic converters, in which reducing agent is purposely introduced into the exhaust gas in order to selectively reduce the nitrogen oxides. It is basically also possible to reduce the nitrogen oxide emissions by means of so-called nitrogen oxide storage catalytic converters, also referred to as LNT. Here, the nitrogen oxides are initially, during a lean-burn mode of the internal combustion engine, absorbed, that is to say collected and stored, in the catalytic converter before being reduced during a regeneration phase for example by means of substoichiometric operation (λ<1) of the internal combustion engine with a lack of oxygen. To minimize the emissions of soot particles, use is made of so-called regenerative particle filters which filter out and store the soot particles from the exhaust gas. The particles are intermittently burned off during the course of the regeneration of the filter.

In the internal combustion engine according to the disclosure, embodiments are advantageous in which at least one exhaust-gas aftertreatment system is provided in the exhaust-gas discharge system.

Different possibilities for exhaust-gas aftertreatment arise corresponding to the different embodiments of the exhaust manifold and/or of the exhaust-gas discharge system.

Exhaust temperature may be measured by one or more temperature sensors (not shown) located in exhaust passage 148. Alternatively, exhaust temperature may be inferred based on engine operating conditions such as speed, load, air-fuel ratio (AFR), spark retard, etc. Further, exhaust temperature may be computed by one or more exhaust gas sensors 128. It may be appreciated that the exhaust gas temperature may alternatively be estimated by any combination of temperature estimation methods listed herein.

Each cylinder of engine 111 may include one or more intake valves and one or more exhaust valves. For example, cylinder 141 is shown including at least one intake poppet valve 150 and at least one exhaust poppet valve 156 located at an upper region of cylinder 141. In some embodiments, each cylinder of engine 111, including cylinder 141, may include at least two intake poppet valves and at least two exhaust poppet valves located at an upper region of the cylinder.

Intake valve 150 may be controlled by controller 121 by cam actuation via cam actuation system 151. Similarly, exhaust valve 156 may be controlled by controller 121 via cam actuation system 153. Cam actuation systems 151 and 153 may each include one or more cams and may utilize one or more of cam profile switching (CPS), variable cam timing (VCT), variable valve timing (VVT) and/or variable valve lift (VVL) systems that may be operated by controller 121 to vary valve operation. The operation of intake valve 150 and exhaust valve 156 may be determined by valve position sensors (not shown) and/or camshaft position sensors 155 and 157, respectively. In alternative embodiments, the intake and/or exhaust valve may be controlled by electric valve actuation. For example, cylinder 141 may alternatively include an intake valve controlled via electric valve actuation and an exhaust valve controlled via cam actuation including CPS and/or VCT systems. In still other embodiments, the intake and exhaust valves may be controlled by a common valve actuator or actuation system, or a variable valve timing actuator or actuation system. A cam timing may be adjusted (by advancing or retarding the VCT system) to adjust an engine dilution in coordination with an EGR flow thereby reducing EGR transients and improving engine performance.

Cylinder 141 can have a compression ratio, which is the ratio of volumes when piston 138 is at bottom dead center to top dead center. Conventionally, the compression ratio is in the range of 9:1 to 10:1. However, in some examples where different fuels are used, the compression ratio may be increased. This may happen, for example, when higher octane fuels or fuels with higher latent enthalpy of vaporization are used. The compression ratio may also be increased if direct injection is used due to its effect on engine knock.

In some embodiments, each cylinder of engine 111 may include a spark plug 192 for initiating combustion. Ignition system 190 can provide an ignition spark to combustion chamber 141 via spark plug 192 in response to spark advance signal SA from controller 121, under select operating modes. However, in some embodiments, spark plug 192 may be omitted, such as where engine 111 may initiate combustion by auto-ignition or by injection of fuel as may be the case with some diesel engines.

As a non-limiting example, cylinder 141 is shown including one fuel injector 166. Fuel injector 166 is shown coupled directly to cylinder 141 for injecting fuel directly therein in proportion to the pulse width of signal FPW received from controller 121 via electronic driver 168. In this manner, fuel injector 166 provides what is known as direct injection (hereafter also referred to as “DI”) of fuel into combustion cylinder 141. While FIG. 1 shows injector 166 as a side injector, it may also be located overhead of the piston, such as near the position of spark plug 192. Fuel may be delivered to fuel injector 166 from a high pressure fuel system 80 including fuel tanks, fuel pumps, and a fuel rail. Alternatively, fuel may be delivered by a single stage fuel pump at lower pressure, in which case the timing of the direct fuel injection may be more limited during the compression stroke than if a high pressure fuel system is used. Further, while not shown, the fuel tanks may have a pressure transducer providing a signal to controller 121. It will be appreciated that, in an alternate embodiment, injector 166 may be a port injector providing fuel into the intake port upstream of cylinder 14. Though FIG. 1 shows a spark ignition engine the present disclosure is also compatible with a compression ignition engine.

As described above, FIG. 1 shows only one cylinder of a multi-cylinder engine. As such each cylinder may similarly include its own set of intake/exhaust valves, fuel injector(s), spark plug, etc.

While not shown, it will be appreciated that engine may further include one or more exhaust gas recirculation passages for diverting at least a portion of exhaust gas from the engine exhaust to the engine intake. As such, by recirculating some exhaust gas, an engine dilution may be affected which may increase engine performance by reducing engine knock, peak cylinder combustion temperatures and pressures, throttling losses, and NOx emissions. The one or more EGR passages may include an LP-EGR passage coupled between the engine intake upstream of the turbocharger compressor and the engine exhaust downstream of the turbine, and configured to provide low pressure (LP) EGR. The one or more EGR passages may further include an HP-EGR passage coupled between the engine intake downstream of the compressor and the engine exhaust upstream of the turbine, and configured to provide high pressure (HP) EGR. In one example, an HP-EGR flow may be provided under conditions such as the absence of boost provided by the turbocharger, while an LP-EGR flow may be provided during conditions such as in the presence of turbocharger boost and/or when an exhaust gas temperature is above a threshold. The LP-EGR flow through the LP-EGR passage may be adjusted via an LP-EGR valve while the HP-EGR flow through the HP-EGR passage may be adjusted via an HP-EGR valve (not shown).

Controller 121 is shown in FIG. 1 as a microcomputer, including microprocessor unit 106, input/output ports 108, an electronic storage medium for executable programs and calibration values shown as read only memory chip 110 in this particular example, random access memory 112, keep alive memory 114, and a data bus. Controller 121 may receive various signals from sensors coupled to engine 111, in addition to those signals previously discussed, including measurement of inducted mass air flow (MAF) from mass air flow sensor 122; engine coolant temperature (ECT) from temperature sensor 116 coupled to cooling sleeve 118; a profile ignition pickup signal (PIP) from Hall effect sensor 120 (or other type) coupled to crankshaft 140; throttle position (TP) from a throttle position sensor; and manifold absolute pressure signal (MAP) from sensor 124. Engine speed signal, RPM, may be generated by controller 121 from signal PIP. Manifold pressure signal MAP from a manifold pressure sensor may be used to provide an indication of vacuum, or pressure, in the intake manifold. Still other sensors may include fuel level sensors and fuel composition sensors coupled to the fuel tank(s) of the fuel system.

Storage medium read-only memory 110 can be programmed with computer readable data representing instructions executable by processor 106 for performing the methods described below as well as other variants that are anticipated but not specifically listed.

FIG. 2 schematically shows a plan view of that portion of the exhaust manifold 7 which is integrated in the cylinder head 152, in a first embodiment of the internal combustion engine.

The associated cylinder head 152 has four cylinders 1, 2, 3, and 4 which are arranged in an in-line configuration along the longitudinal axis of the cylinder head. The cylinder head 152 therefore has two outer cylinders 1 and 4 and two inner cylinders 2 and 3.

Each cylinder 1, 2, 3, and 4 has two outlet openings 5 which are adjoined by exhaust lines 8 of the exhaust-gas discharge system 6 for discharging the exhaust gases. The exhaust lines 8 of the cylinders 1, 2, 3, and 4 merge to form an overall exhaust line 10 in stages. The exhaust lines 8 associated with cylinder group 18 comprising cylinders 1 and 2 merge into a single component exhaust line 9 combining the exhaust flow of cylinders 1 and 2. The exhaust lines 8 of cylinder group 19, comprising cylinders 1 and 2, merge to form a component exhaust line 9 combining the exhaust flow of cylinders 3 and 4. The component exhaust lines 9 are maintained separate from one another for a distance before the two component exhaust lines 9 of the four cylinders 1, 2, 3, and 4 merge to form an overall exhaust line 10.

The exhaust manifold 7 illustrated in FIG. 2 is an exhaust manifold 7 fully integrated in the cylinder head 152, that is to say the exhaust lines 8 of the cylinders 1, 2, 3, and 4 merge to form an overall exhaust line 10 within the cylinder head such that the exhaust manifold 7 is formed.

Embodiments of the internal combustion engine are advantageous in which the turbine of the at least one exhaust-gas turbocharger is arranged in the overall exhaust line.

Embodiments of the internal combustion engine may be advantageous in which the at least one exhaust-gas aftertreatment system is arranged in the overall exhaust line. All of the exhaust gas shares a common aftertreatment system.

FIG. 3 schematically shows a plan view of that portion of the exhaust manifold 7 which is integrated in the cylinder head 152, in a second embodiment of the internal combustion engine. In this embodiment the component exhaust lines do not merge within the cylinder head 152 but rather exit the cylinder head 152 as two component exhaust manifolds 7a and 7b. One component exhaust manifold 7a associated with cylinders 1 and 2 of a first cylinder group 18 and a second component exhaust manifold 7b associated with cylinders 3 and 4 of the second cylinder group 19. FIG. 3 explains the differences in relation to the embodiment illustrated in FIG. 2, for which reason reference is otherwise made to FIG. 2. The same reference symbols have been used for the same components.

The exhaust lines 8 of the two cylinder groups merge to form component exhaust lines 9 within the cylinder head such that two integrated component exhaust manifolds 7a and 7b are formed. By contrast to the embodiment of FIG. 2, however, the component exhaust lines 9 do not merge to form an overall exhaust line within the cylinder head, such that the component exhaust lines 9 are maintained separated from one another over a greater length. The component exhaust manifolds 7a and 7b merge outside of the cylinder head to form a single exhaust line (not shown). Furthermore the two component exhaust manifolds 7a and 7b enter twin scroll turbine 23 of a turbocharger such as exhaust turbine 176 (shown in FIG. 1). The component exhaust manifolds 7a and 7b are maintained separate and vent exhaust flow from cylinders 1 and 2 into one inlet of a twin scroll turbine 23 via component exhaust manifold 7a and vent exhaust flow from cylinders 3 and 4 into a second inlet of twin scroll turbine 23 via component exhaust manifold 7b.

In internal combustion engines in which the component exhaust lines of the cylinders merge to form an overall exhaust line outside the at least one cylinder head, embodiments of the internal combustion engine may also be advantageous wherein the turbine of the at least one exhaust-gas turbocharger is a twin scroll turbine which has an inlet region with two inlet ducts, wherein in each case one of the two component exhaust lines opens into one of the two inlet ducts.

The embodiment is also advantageous because the partition between the inlet ducts of the twin scroll turbine runs vertically, and the two component exhaust lines emerge from the head perpendicular thereto, offset with respect to one another along the longitudinal axis of the cylinder head. In this respect, the arrangement of the partition or of the inlet ducts corresponds to the outlet structure of the two component exhaust lines.

It is nevertheless also possible for the turbine to be designed as a twin scroll turbine even if it is arranged in the overall exhaust line.

Furthermore, embodiments may also be advantageous wherein a turbine is arranged in each of the two component exhaust lines.

The torque characteristic of a supercharged internal combustion engine can also be noticeably increased by means of two turbines arranged in parallel. In the present case, it is possible for the two small turbines to be arranged in a close-coupled configuration, that is to say directly adjacent to the cylinder head.

Also, with a configuration as shown in FIG. 3, embodiments of the internal combustion engine may be advantageous wherein an exhaust-gas aftertreatment system is arranged in each of the two component exhaust lines. In the overall exhaust line, which the two component exhaust lines merge to form downstream, there may also be provided a further exhaust-gas aftertreatment system, if appropriate also a different type of exhaust-gas aftertreatment system.

As already described, it is advantageous for the exhaust manifold to be substantially integrated into the at least one cylinder head, that is to say for the merging of the exhaust lines to take place to the greatest possible extent already in the cylinder head, because this leads to a more compact design, permits dense packaging and yields cost advantages and weight advantages. Furthermore, advantages can also be attained with regard to the response behavior of an exhaust-gas turbocharger provided in the exhaust-gas discharge system or of an exhaust-gas aftertreatment system and with regard to the material to be used for the manifold.

For the reasons stated above, embodiments of the internal combustion engine are advantageous in particular in which the exhaust lines of the cylinder groups merge to form component exhaust lines within the at least one cylinder head, such that two integrated component exhaust manifolds are formed.

An internal combustion engine according to the disclosure may also have two cylinder heads, for example if eight cylinders are arranged distributed on two cylinder banks. The merging according to the disclosure of the exhaust lines into the then two cylinder heads may be utilized then, too, to increase the charge exchange and increase the torque availability.

That is to say, the merging of the exhaust lines of each of the two cylinder groups to form a component exhaust line associated with the cylinder group takes place within the cylinder head in the embodiment in question.

Embodiments of the internal combustion engine are advantageous in which the exhaust lines of the cylinders merge to form an overall exhaust line within the at least one cylinder head, such that one integrated exhaust manifold is formed.

In the embodiment in question, the component exhaust lines formed in the cylinder head merge to form an overall exhaust line already within the cylinder head. In this respect, all of the exhaust gas conducted by the exhaust-gas discharge system exits the cylinder head through a single outlet opening on the outlet-side exterior side of the cylinder head.

The present embodiment is characterized by a very compact design which has all the advantages offered by an exhaust manifold wholly integrated into the cylinder head.

Nevertheless, embodiments of the internal combustion engine may also be advantageous in which the component exhaust lines of the cylinders merge to form an overall exhaust line outside the at least one cylinder head. Here, the exhaust lines of the cylinders of a group merge to form a component exhaust line preferably within the cylinder head. The exhaust manifold is then of modular construction and is composed of a manifold portion integrated in the cylinder head, specifically two component exhaust manifolds, and an external manifold or manifold portion.

The exhaust-gas flows of the component exhaust lines are kept separate from one another at least until they exit the cylinder head, such that the exhaust-gas discharge system emerges from the cylinder head in the form of two outlet openings. The component exhaust lines are merged to form an overall exhaust line downstream of the cylinder head, and thus outside the cylinder head. This may take place upstream or downstream of an exhaust-gas aftertreatment system or an exhaust-gas turbocharging system.

Embodiments of the internal combustion engine are advantageous in which each cylinder has at least two outlet openings for discharging the exhaust gases out of the cylinder.

As has already been stated, during the charge exchange, it is sought to obtain a fast opening of the greatest possible flow cross sections in order to keep the throttling losses in the outflowing exhaust-gas flows low and to ensure effective discharging of the exhaust gases. It is therefore advantageous for the cylinders to be provided with two or more outlet openings.

A method for operating an internal combustion engine of a type described above, may be achieved by a method in which, in the cylinders, the combustion is initiated at intervals of 180° CA.

The initiation, that is to say introduction, of the combustion may take place either by means of externally-applied ignition, for example by means of a spark plug, or else by means of auto-ignition or compression ignition. In this respect, the method can be implemented in applied-ignition engines and also in diesel engines and hybrid internal combustion engines.

That which has been stated in connection with the internal combustion engine according to the disclosure likewise applies to the method according to the disclosure.

In internal combustion engines whose cylinders are equipped with ignition devices for initiating an applied ignition, method variants may be advantageous wherein the cylinders are ignited by means of ignition devices in the sequence 1-3-2-4 and at intervals of 180° CA. Here, the cylinders are enumerated and numbered sequentially along the longitudinal axis of the at least one cylinder head proceeding from an outer cylinder.

Method variants may however also be advantageous in which the cylinders are ignited by means of ignition devices in the sequence 1-4-2-3 and at intervals of 180° CA. Here, the cylinders are enumerated and numbered sequentially along the longitudinal axis of the at least one cylinder head proceeding from an outer cylinder.

In the two above method variants, the two cylinders of a cylinder group have the greatest possible offset with regard to their working processes, specifically a thermodynamic offset of 360° CA. The combustion is initiated by means of applied ignition alternately in a cylinder of one cylinder group and a cylinder of the other cylinder group.

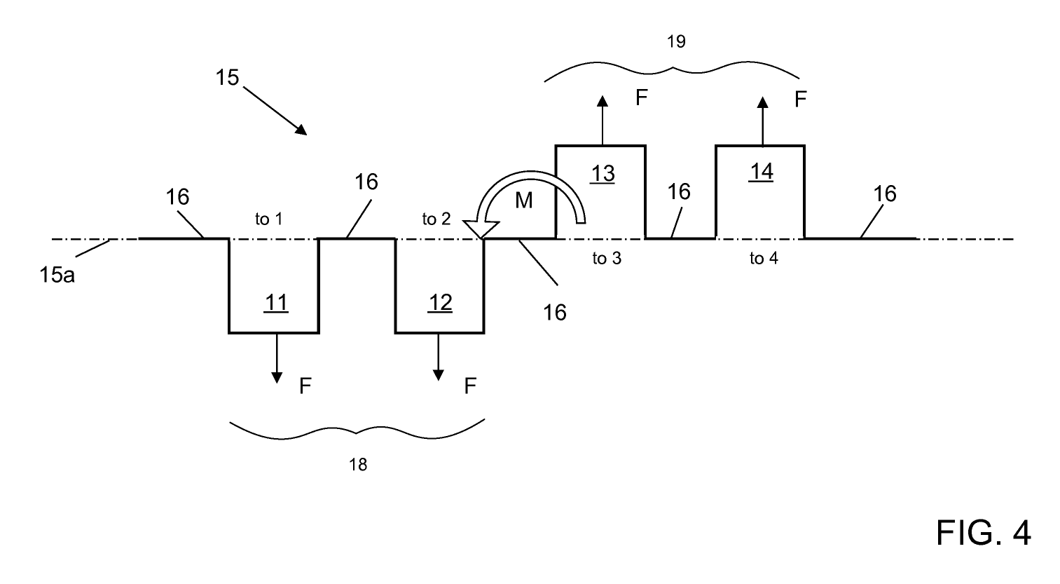

FIG. 4 shows an embodiment of the crankshaft 15 of the internal combustion engine as a diagrammatic sketch.

The illustrated crankshaft 15 has five bearings 16 and has, for each cylinder, a crankshaft throw 11, 12, 13, and 14 associated with the cylinders 1, 2, 3, and 4 respectively. The crankshaft throws 11, 12, 13, and 14 are arranged spaced apart from one another along the longitudinal axis 15a of the crankshaft 15, wherein the two crankshaft throws 11 and 12, and 13 and 14 of the two cylinders of each cylinder group 18 and 19 have no offset in the circumferential direction about the longitudinal axis 15a of the crankshaft 15, such that the cylinders within each cylinder group are mechanically synchronous cylinders. The crankshaft throws 11 and 12 of cylinders 1 and 2, that is to say of the first cylinder group 18, are arranged so as to be offset by 180° in the circumferential direction on the crankshaft 15 in relation to the crankshaft throws 13 and 14 of cylinders 3 and 4, that is to say of the second cylinder group 19.

The mass forces F which act on the crankshaft throws 11, 12, 13, and 14 are indicated. The mass moment M resulting from the mass forces should preferably be balanced by means of mass balancing. Mass balancing can be achieved by weights located on ends of the crank shaft 15, such as counterweights (not shown), to counter balance the mass forces of the crankshaft throws 11, 12, 13, and 14. Counterweights may additionally be located in other regions of the crankshaft. Alternatively, or in addition, counterweights may be located opposite each of the crankshaft throws (not shown). Additionally, a flywheel may be located on crankshaft 15 and may serve to further balance mass forces F.

The crank shaft 15 and it's arrangement of crank throws, 11 and 12 synchronous and 14 and 14 synchronous, allow for sequential firing within combustion chambers in a 1-3-2-4 order, or a 1-4-2-3 order such that the offset of cylinders firing within a cylinder group is 360° CA. This offset has the effect of minimizing or negating the dynamic wave phenomena describe above.

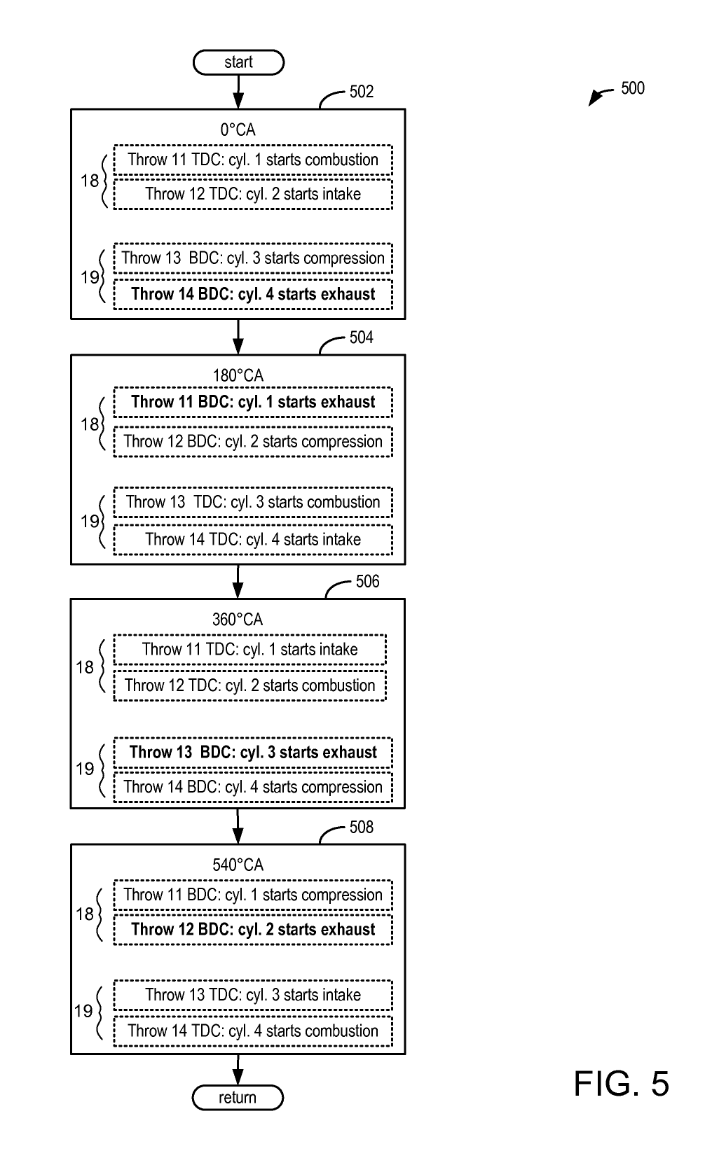

Referring now to FIG. 5 a sequence 500 of cylinder events in accordance with a method and systems of the present disclosure is shown as they correlate to the angle of crankshaft 15. This sequence 500 of cylinder events is representative of an embodiment where cylinders fire in a 1-3-4-2 fashion. However, it is possible to amend the sequence of combustion such that cylinders fire in a 1-4-2-3 order (not shown). In sequence 500 the first group 18 and second group 19 of cylinders are shown paired. Each cylinder of a group, for example cylinder 1 and 2 of group 18, controlled by cylinder throws 11 and 12, exhaust into exhaust lines 8 of an exhaust manifold 7 (shown in FIGS. 2 and 3). The exhaust lines 8 which vent exhaust from cylinder 1 and 2 of first cylinder group 18 are segregated from the exhaust lines 8 which vent exhaust from cylinders 3 and 4 of the second cylinder group 19.

At 502, crankshaft 15 is at 0° CA. The first cylinder group 18 comprises throw 11 and throw 12 operating cylinders 1 and 2 respectively. Throws 11 and 12 are at top dead center (TDC). Cylinder 1 starts its combustion stroke and cylinder 2 starts the intake stroke. In the second cylinder group 19, throws 13 and 14 operating cylinder 3 and 5 respectively are at bottom dead center (BDC). Cylinder 3 starts the compression stroke and cylinder 14 starts the exhaust stroke.

At 504, crankshaft 15 is at 180° CA. Within first cylinder group 18, throws 11 and 12 are at BDC, resulting in cylinder 1 starting the exhaust stroke and cylinder 2 starting the compression stroke. Throws 13 and 14 of second cylinder group 19 are at TDC, resulting in cylinder 3 starting the combustion stroke, and cylinder 4 starting the intake stroke.

At 506, crankshaft 15 is at 360° CA. Within first cylinder group 18, throws 11 and 12 are at TDC where cylinder 1 starts its intake stroke and cylinder 2 starts its combustion stroke. At 360° CA throws 13 and 14 of cylinder group 19 are at BDC where cylinder 3 starts its exhaust stroke and cylinder 4 starts its compression stroke.

At 508, crankshaft 15 is at 540° CA. Throws 11 and 12 of the first cylinder group 18 are then at BDC where cylinder 1 starts the compression stroke and cylinder 2 starts its exhaust stroke. Throws 13 and 14 of the second cylinder group 19, are at TDC where cylinder 3 starts its intake stroke and cylinder 4 starts its combustion stroke.

The sequence 500 of cylinder events then returns.

Throughout sequence 500 the cylinder starting the exhaust stroke is shown in bold to illustrate that the exhaust stroke of each of the cylinders if offset by 180° CA and exhaust of cylinders within a cylinder group is offset by 360° CA. This offset of cylinders within a cylinder group minimizes or negates the dynamic wave phenomenon which may decrease torque and power via exhaust backpressure in traditional exhaust manifolds with sequential exhaust of adjacent cylinders.

The present disclosure describes a system for an engine comprising: a crankshaft with four crank throws, wherein, the first and the second crank throw are arranged offset by 180° CA from the third and the fourth crank throws; four cylinders corresponding to the four crank throws, the four cylinders arranged in two cylinder groups, the first cylinder group comprising the first and second cylinder, and the second cylinder group comprising the third and fourth cylinder; an exhaust manifold, wherein, exhaust lines within each of the two cylinder groups merge forming two component exhaust lines, and the two component exhaust lines merge into an overall exhaust line; and an ignition sequence such that each ignition is offset by 180° CA, and ignition of cylinders within a cylinder group is offset by 360° CA. An exhaust gas discharge described in the present disclosure allows for short exhaust lines which use less space in an engine compartment as well as minimize heat losses prior to exhaust gas aftertreatment. An ignition sequence in which ignition of grouped cylinders, corresponding to a single component exhaust line, is offset by 360° CA minimizes backpressure in a sequentially fired, adjacent cylinder. The manner in which exhaust lines are segregated within an exhaust manifold of the present disclosure directs exhaust gas flow away from the following cylinder fired using an ignition sequence of the present disclosure.

It will be appreciated that the configurations and methods disclosed herein are exemplary in nature, and that these specific embodiments are not to be considered in a limiting sense, because numerous variations are possible. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An internal combustion engine comprising:
at least one cylinder head;
four cylinders in an in-line arrangement along a longitudinal axis of the at least one cylinder head; and
a crankshaft which has, for each of the four cylinders, a crankshaft throw corresponding to the cylinder, wherein the crankshaft throws are arranged spaced apart from one another along a longitudinal axis of the crankshaft; each of the cylinders having at least one outlet opening for discharging exhaust gases out of the cylinder via an exhaust-gas discharge system, for which purpose each outlet opening is adjoined by an exhaust line; the four cylinders being configured in two cylinder groups, wherein in each case one outer cylinder and an adjacent inner cylinder form the cylinder group; and the exhaust lines of the four cylinders merging to form an overall exhaust line, such that an exhaust manifold is formed, in stages, the exhaust lines of each of the two cylinder groups merging, to form two component exhaust lines before the two component exhaust lines of the two cylinder groups merge to form an overall exhaust line, the two crankshaft throws of the two cylinders of each of the cylinder groups having no offset in a circumferential direction about the longitudinal axis of the crankshaft, such that the two cylinders of the cylinder group are mechanically synchronous cylinders, and the crankshaft throws of a first of the two cylinder groups are arranged so as to be offset by 180° in the circumferential direction on the crankshaft in relation to the crankshaft throws of a second of the two cylinder groups.

2. The internal combustion engine as claimed in claim 1, wherein the exhaust lines of the two cylinder groups merge to form the component exhaust lines within the at least one cylinder head, such that two integrated component exhaust manifolds are formed.

3. The internal combustion engine as claimed in claim 1, wherein the exhaust lines of the four cylinders merge to form the overall exhaust line within the at least one cylinder head, such that a single integrated exhaust manifold is formed.

4. The internal combustion engine as claimed in claim 2, wherein the component exhaust lines of the two cylinder groups merge to form the overall exhaust line outside the at least one cylinder head.

5. The internal combustion engine as claimed in claim 1, wherein the internal combustion engine is a naturally aspirated engine.

6. The internal combustion engine as claimed in claim 1, further comprising at least one exhaust-gas turbocharger which comprises a turbine arranged in the exhaust-gas discharge system.

7. The internal combustion engine as claimed in claim 6, wherein a turbine of the at least one exhaust-gas turbocharger is arranged in the overall exhaust line.

8. The internal combustion engine as claimed in claim 6, wherein the component exhaust lines of the two cylinder groups merge to form the overall exhaust line outside the at least one cylinder head, wherein the turbine of the at least one exhaust-gas turbocharger is a twin scroll turbine which has two inlet ducts, wherein, in each case, one of the two component exhaust lines opens into one of the two inlet ducts.

9. The internal combustion engine as claimed in claim 6, wherein two exhaust-gas turbochargers are provided which comprise two turbines arranged in the exhaust-gas discharge system.

10. The internal combustion engine as claimed in claim 9, wherein the two turbines in the overall exhaust line are arranged in series.

11. The internal combustion engine as claimed in claim 9, wherein the component exhaust lines of the two cylinder groups merge to form the overall exhaust line outside the at least one cylinder head, wherein the two turbines are arranged one in each of the two component exhaust lines.

12. The internal combustion engine as claimed in claim 1, further comprising at least one exhaust-gas aftertreatment system in the exhaust-gas discharge system.

13. The internal combustion engine as claimed in claim 12, wherein the at least one exhaust-gas aftertreatment system is arranged in the overall exhaust line.

14. The internal combustion engine as claimed in claim 12, wherein the component exhaust lines of the two cylinder groups merge to form the overall exhaust line outside the at least one cylinder head, wherein one of the at least one exhaust-gas aftertreatment systems is arranged in each of the two component exhaust lines.

15. A method for an engine comprising:
initiating combustion in four cylinders at intervals of 180° CA in the engine, the engine comprising a crankshaft with four crank throws, a first and second of the four crank throws arranged mechanically synchronously and a third and fourth of the four crank throws arranged mechanically synchronously separated by 180° CA from the first and second crank throws, the four crank throws corresponding to the four cylinders;
exhausting combustion products from each of the four cylinders at intervals of 180° CA into exhaust lines of the four cylinders which merge to form an overall exhaust line, such that an exhaust manifold is formed, in stages, wherein the exhaust lines of each cylinder group merge, in each case, to form two component exhaust lines, the two component exhaust lines of the two cylinder groups merge to form the overall exhaust line.

16. The method as claimed in claim 15, wherein the four cylinders are equipped with ignition devices for initiating an applied ignition, wherein the four cylinders are ignited by the ignition devices in a sequence 1-3-2-4 and at intervals of 180° CA, wherein the four cylinders are enumerated and numbered sequentially along a longitudinal axis of the crankshaft proceeding from an outer cylinder.

17. The method as claimed in claim 15, wherein the four cylinders are equipped with ignition devices for initiating the applied ignition, wherein the four cylinders are ignited by the ignition devices in a sequence 1-4-2-3 and at intervals of 180° CA, wherein the cylinders are enumerated and numbered sequentially along the longitudinal axis of the at least one cylinder head proceeding from the outer cylinder.

18. An engine method, comprising:
combining exhaust flow of a first and second cylinder separately from combining exhaust flow of a third and fourth cylinder while maintaining the combined exhaust flows separate throughout an integrated exhaust manifold cylinder head; and
operating the engine with the first and second cylinders offset by 360° CA and the third and fourth cylinders offset by 360° CA.

19. The method of claim 18, wherein the engine comprises a crankshaft with crank throws of the first and second cylinders arranged mechanically synchronously and crank throws of the third and fourth cylinders arranged mechanically synchronously offset to the crank throws of the first and second cylinders by 180° CA.

20. The method of claim 18, further comprising delivering the combined exhaust flow of the first and second cylinders to a first inlet of a twin scroll turbocharger turbine and delivering the combined exhaust flow of the third and fourth cylinders to a second inlet of the twin scroll turbocharger turbine.
